(19) United States
(12) Patent Application Publication
(10) Pub. No.: US 2015/0166931 A1
(43) Pub. Date: Jun. 18, 2015

(54) SEMI-CONTINUOUS ACIDULATION PROCESS

(71) Applicant: ARIZONA CHEMICAL COMPANY, LLC, Jacksonville, FL (US)

(72) Inventors: Robert E Bowles, Lynn Haven, GA (US); Joseph H Griffin, Rincon, GA (US)

(73) Assignee: ARIZONA CHEMICAL COMPANY, LLC, Jacksonville, FL (US)

(21) Appl. No.: 14/401,006

(22) PCT Filed: May 2, 2013
(86) PCT No.: PCT/US2013/039322

§ 371 Date: Nov. 13, 2014

Related U.S. Application Data
(60) Provisional application No. 61/646,604, filed on May 14, 2012.

(51) Int. Cl. C11B 13/02

(52) U.S. Cl. CPC C11B 13/02

(57) ABSTRACT

A semi-continuous acidulation process for converting tall oil soap to crude tall oil is disclosed. Reactants are continuously mixed, and the product mixture is continuously transferred to a settling tank having a conical lower section and a capacity at least 25 times that of the mixer. Batches settle to give a solid phase comprising calcium sulfate, a clean spent acid phase, a dirty spent acid phase, and a crude tall oil phase. Each phase is removed sequentially through a port at or near the bottom of the settling tank. Compared with traditional batch acidulation, continuous mixing minimizes the corrosive environment and enables the use of less expensive materials for the settling tank. Sequential removal of four phases from one port allows calcium sulfate to be purged from every batch, permits clean separation of clean spent acid from dirty spent acid, and enables clean recovery of tall oil. Compared with processes that isolate product continuously, inherent difficulties in using centrifuges or continuous decanters to separate four phases are avoided. The process facilitates generation of clean alkaline brine and integration of new soap washing methods that enable improved conversion yields of CTO and better removal of calcium from the soap.

### FIELD OF THE INVENTION

The invention relates to the production of crude tall oil, and in particular, to a process for acidulating tall oil soap.

### BACKGROUND OF THE INVENTION

Tall oil is an important by-product of the Kraft process for pulping wood, especially wood derived from pine trees. A resinous, oily liquid, tall oil comprises a mixture of rosin acids and fatty acids and may be used in soaps, emulsions, lubricants, fuels and other applications. Crude tall oil (CTO) usually contains rosins, unsaponifiable sterols, resin acids (such as abietic acid), fatty acids (such as palmitic, oleic and linoleic acids), fatty alcohols, other sterols, and other alkyl hydrocarbon derivatives. The fatty acid fraction of tall oil (TOFA or tall oil fatty adds) is used to produce soaps, lubricants, and other products. Other related products include TOFA esters and tall oil rosins.

Crude tall oil soap is normally separated from black liquor of the Kraft process and is sent to an “acidulation” unit in which the soap is acidified, typically with concentrated sulfuric acid, to convert the soap to crude tall oil. Acidulation generates a spent acid phase along with the crude tall oil. If that were the end of the story, phase separation might be academic. However, acidulation also generates precipitates, principally calcium sulfate, and a “rag layer” containing some crude tall oil, spent acid, and lignin. Clean separation of these four phases is essential for good economics, but it can be tricky to achieve. For another description of the four phases, see U.S. Pat. No. 4,238,304 (col. 2, II. 14-23).

A traditional batch acidulation process utilizes a large-volume unit, often with a capacity of tens of thousands of gallons, in which both acidification and a subsequent phase separation are performed. The unit is charged with tall oil soap, water, and sulfuric acid, and the reaction mixture is well-agitated and heated with steam to the desired reaction temperature. When conversion of the soap is complete, stirring is discontinued, and the phases are allowed to separate. The upper phase of crude tall oil is withdrawn, typically with a winch-operated skimmer pipe. Spent acid is then drained from an outlet at or near the bottom of the vessel. For examples of traditional batch acidulation units, see FIG. 2, below, and U.S. Pat. No. 4,238,304, particularly FIG. 1.

Batch acidulation suffers from disadvantages. First, the large reactor batches can require long settling times, often eight hours or more. Second, most units use a manually operated skimmer pipe. The operator usually needs to look inside the top of the reactor to locate the interface between the oil and rag layers. Inevitably, a substantial amount of oil is sacrificed when the operator strives to drain an oil phase that is free of any rag layer. Third, because hydrogen sulfide may be present in the reactor, requiring personnel to look inside the open vessel is potentially unsafe. Fourth, the usual flat-bottom vessel does not permit good separation of precipitated calcium sulfate. Over time, large chunks of material accumulate, eventually forcing a shutdown for reactor cleaning. Fifth, because of the highly acidic reaction conditions and opportunities for localized corrosion, the reactor must be brick-lined and constructed from expensive alloys such as Alloy 20 or 904L. Most traditional batch reactors require frequent and expensive maintenance. The large agitators and shafts must also be fabricated from Alloy 20, adding further expense. Sixth, most batch units are ill-suited to use the modern instrumentation needed to accurately monitor conversion yield, acid consumption, brine generation, and other important metrics.

Current “best practices” call for continuous acidulation of tall oil soap and continuous product recovery, typically by gravity or centrifuge decanting. The continuous process uses a relatively small reactor for acidulation. In gravity decanting, separation is performed by continuously removing the tall oil phase from the top of a decanter and removing the spent acid phase from the bottom at a rate effective to keep the oil-rag layer interface at a relatively constant level in the decanter.

Continuous gravity systems have difficulty distinguishing among the different phases, and they do not permit an easy separation of the clean spent acid phase from the dirty spent acid phase. Continuous plants that use centrifuges are also unable to differentiate clean spent acid from the dirty spent acid layer, so these layers are usually mixed. Moreover, centrifuges are high-speed, precision instruments that demand constant maintenance and can break down unexpectedly, causing substantial down time. Continuous gravity and centrifuge systems are also unable to deal with the calcium sulfate precipitate, which means that the spent acid phase will require further processing to remove it.

Much of the patent literature related to acidulation processes focuses on using carbon dioxide for at least part of the acidulation. The goal is to reduce the load of sulfate salts generated that will ultimately be returned to the mill for processing. For example, U.S. Pat. No. 3,901,869 teaches to use an initial acidification with carbon dioxide, followed by sulfuric acid, to reduce by 40% to amount of sulfuric acid needed. For additional examples of using carbon dioxide in an acidulation process, see U.S. Pat. Nos. 4,075,188; 5,283,319; and 6,172,183. Unfortunately, pre-acidifying with carbon dioxide forces an additional separation step. Carbon dioxide treatment generates a spent bicarbonate brine phase that must be separated from the resulting “soapy oil” (a roughly 40:60 mixture of CTO and unconverted soap). After the bicarbonate brine phase is removed, the soapy oil is treated with sulfuric acid to complete the acidulation. Thereafter, the spent sulfuric acid phase is removed. Because a second phase separation step is needed, the conversion yield of CTO is reduced compared with that of a sulfuric acid-only process.

Processes for acidulating tall oil soap were reviewed by Faustino L. Prado in a series of papers from the 1980s (see, e.g., “Tall Oil Soap Acidulation Processes,” presented at the American Oil Chemists' Society annual meeting, Chicago, Ill., May 1983 and “Tall Oil Soap Acidulation: A Review of Technology,” presented at the Pulp Chemicals Association, Third Special Recovery Conference, Atlanta, Ga., January 1984). The processes reviewed included: (a) batch acidulation with batch gravity decanting; (b) continuous acidulation with batch gravity decanting; (c) continuous acidulation with continuous gravity decanting; and (d) continuous acidulation with continuous centrifugal decanting. The pros and cons of each process are indicated, and a flow diagram for each is given. For the present discussion, process (b), the “semi-batch” process, is most relevant. The diagram for the semi-batch process shows tall oil and brine from the continuous acidulation unit entering the decanter at the top and a series of products exiting one side of the decanter, perhaps indicating side-draw removal of different phases. The diagram does not suggest sequential removal of phases from a port at or near the bottom of the decanter.

J. P. Krumbein (“Efficient Tall Oil Plant Can Benefit Kraft Mils,” Southern Pulp and Paper, August 1984, pp. 36-38) describes design aspects of plants that utilize tall oil acidulation. A process description and flow diagram (FIG. 1) are included. The process is described as a “batch” process, but it uses the agitated reactor exclusively for acidulation. When acidulation is complete, a reactor batch is pumped to one of two decanters. The decanters are kept full at all times with crude tall oil occupying the upper section and spent acid the lower section. As each new batch is transferred to a decanter, settled CTO from an earlier batch is displaced to storage, and spent acid flows through a gravity leg to a brine neutralizing tank where it is treated with caustic. The process is best characterized as involving batch acidulation and continuous decanting. Similar to the process described by Prado, this process decants phases at different levels and does not sequentially remove phases from a port at or near the bottom of the decanter.

Recently, we described (see PCT Int. Appl. WO/2012034112, published Mar. 15, 2012, “Method for Producing Crude Tall Oil by Soap Washing with Calcium Carbonate Removal,” hereinafter also called “the '112 publication”) a process for producing crude tall oil that involves soap washing to remove calcium and lignates. As we noted earlier, processes that utilize soap washing tend to accumulate calcium sulfate. The calcium sulfate, if left unchecked, ultimately fouls process equipment and forces frequent shutdowns for cleaning decanters and other equipment (see the background of the '112 publication for a more complete discussion). Perhaps because of the issues with calcium sulfate fouling, soap washing was largely abandoned by the industry. As we described in the '112 publication, black liquor soap comprising tall oil soap, lignates, and calcium carbonate is washed with a clean, alkaline wash medium prior to acidulation. This step generates washed tall oil soap and a mixture of fortified brine, lignates, and calcium carbonate. The calcium carbonate can be removed by further water washing, filtration, or centrifugation, while the aqueous lignates can be used for fuel. Acidulation of the washed tall oil soap gives crude tall oil and a spent acid phase. Caustic is added to the clean spent acid to give the clean alkaline wash medium used for soap washing. Because calcium is removed in the washing step, it is not returned to the plant's weak liquor system and therefore does not accumulate.

Prado, supra, mentions soap washing to remove lignin in one paper, but calcium carbonate removal is not discussed; the semi-batch process flow diagram does not illustrate soap washing or calcium removal. As discussed above, unless it is removed, calcium carbonate will accumulate in the brine phase, eventually causing a process upset.

Krumbein, supra, Indicates that calcium sulfate salts can be removed periodically as a sludge from the bottom of the decanters. He also notes that frequent (every week or two) cleaning of the decanters is needed. Krumbein's process addresses removal of lignin and to a limited extent the direct removal of calcium sulfate. However, this process would result in calcium cycling up in a liquor system to which it is attached which would return to the wash process via black liquor, at least if the fortified brine from the wash is sent to the weak liquor system (as is logical under the circumstances). The reference does not specifically address where the fortified brine should be sent (other than the pulp mill recovery/black liquor system). It is common practice in the industry to avoid sending streams to the sewer and recycle them instead if possible. There does not seem to be any provision for clarification of the fortified brine in any case, which would remove more of the calcium as calcium carbonate.

In sum, the industry would benefit from an improved process for acidulation. In particular, a process that overcomes disadvantages of a traditional batch process (e.g., need for special alloys and brick-lined reactors, yield losses in isolating CTO from the rag layer) and also sidesteps problems with continuous processes that rely on centrifugal separation (inability to separate a four-phase mixture that includes a solid calcium sulfate phase) or continuous decanting. An ideal process could integrate with black liquor soap washing in a way that effectively avoids calcium and lignin accumulation.

### SUMMARY OF THE INVENTION

The invention relates to a semi-continuous acidulation process for converting tall oil soap to crude tall oil. First, in one or more mixers, reactants comprising a tall oil soap, sulfuric add, and water are continuously mixed at a temperature within the range of 80° C. to 100° C. The reaction mixture(s) from this step are then continuously transferred to a settling tank having a conical lower section and a capacity at least 25 times that of the mixer. Batches of the transferred reaction mixture are allowed to settle to give, in order of decreasing density, a solid phase comprising calcium sulfate, a clean spent acid phase, a dirty spent acid phase comprising lignin, and a crude tall oil phase. For each batch, each phase is removed sequentially from the settling tank through a port at or near the bottom of the settling tank.

Compared with traditional batch acidulation processes, the continuous mixing of the inventive process minimizes the corrosive environment and enables the use of less expensive materials for the settling tank. Sequential removal of all four phases from one port in the lower conical section of the settling tank allows solids comprising calcium sulfate to be purged from every batch, permits clean separation of clean spent acid from dirty spent acid, and enables clean recovery of tall oil not possible in the usual top-phase decantation using a skimmer pipe. Compared with processes that isolate product continuously, the inventive process avoids the inherent difficulties in using centrifuges or continuous decanters to separate four distinct phases.

The inventive process also facilitates generation of clean alkaline brine (by neutralization of clean spent acid) that can be used without further processing to wash black liquor soap prior to acidulation. Thus, the recent improvements in soap washing technology readily integrate with the instant inventive process, enabling improved conversion yields of CTO and better removal of calcium from the soap.

### BRIEF DESCRIPTION OF THE DRAWINGS

FIG. 1 depicts a reactor design that utilizes the semi-continuous acidulation process of the invention, including continuous reactant mixing and batch settling/phase separation.

FIG. 2 depicts a traditional batch reactor design useful for batch mixing and batch settling/phase separation.

Although the figures are not required for understanding the invention, they are included here to help highlight different aspects. The figures are mere illustrations and are not intended to limit the scope of the claimed subject matter.

### DETAILED DESCRIPTION OF THE INVENTION

The invention relates to a semi-continuous acidulation process for converting tall oil soap to crude tall oil. The process is characterized by a unique combination of continuous mixing and batch-wise isolation of four distinct products.

The reactants, which comprise tall oil soap (also called “black liquor soap”), sulfuric acid, and water, are continuously mixed in one or more mixers. The reactants are combined at a temperature within the range of 80° C. to 100° C., more preferably from 90° C. to 100° C., most preferably from 95° C. to 100° C. Heating is accomplished by any suitable means. In a preferred aspect, the temperature is achieved and maintained by injecting steam into the reactor.

Tall oil soap is by-product of the Kraft process for pulping wood. In the Kraft process, wood chips are digested with a mixture of sodium hydroxide and sodium sulfide (“white liquor”) and washed to isolate cellulose fibers (the “pulp”) from a liquid phase (“black liquor”) that contains crude tall oil soap, lignates, carbohydrates, and inorganic salts. Concentration of the black liquor in evaporators allows the soap to be skimmed off and processed to tall oil, while the remaining black liquor is further concentrated and eventually burned in a “recovery boiler” to recover the inorganic salts (e.g., sodium carbonate, sodium sulfide). Treatment of these with lime (CaO) regenerates the sodium hydroxide used, along with sodium sulfide, to digest the wood chips. See, e.g., PCT Int. Publ. No. WO/2012034112, especially FIG. 7.

Suitable tall oil soap for use in the inventive process is conveniently obtained directly from paper mills as a by-product. Suitable tall oil soap can come from a single mil, but it is more often a composite from multiple mill sources. The content of the soap varies, but it normally contains crude tall oil soap, water, calcium carbonate, lignates, and entrained black liquor.

Sulfuric acid is used in an amount effective to convert the tall oil soap to crude tall oil. Usually, an excess of the acid is used. The source, concentration, and purity level of the sulfuric acid generally are not critical. Commercially available sulfuric acid is convenient and suitable for use.

Continuous mixing of reactants, also referred to herein as “process intensification,” is preferably accomplished in one or more high-intensity or dynamic mixers, preferably under mild pressure (e.g., 1-2 bar). Two or even three dynamic mixers might be preferred depending on their size, the throughput rates, the settling tank volume, and other factors. It is convenient to use the mixer(s) in a manner such that the rate of transfer of the reaction mixture is effective to fill the settling tank within 1 to 5 hours, preferably within about 3 hours. Compared with traditional batch reactors, however, these mixers are much smaller; they are at least 25 times, often 100 to 500 times, smaller than an ordinary batch reactor, which normally holds thousands or tens of thousands of gallons of liquid mixture. In a convenient approach, the reactants are combined in a pipe that feeds a small, pressurized mixer that then feeds into the settling tank. Because the reactants are heated and mixed outside the settling tank, conditions inside the setting tank are much less corrosive. Preferably, the acid concentration in the settling tank remains below 10%, more preferably below 5%. This allows less expensive materials to be used for construction of the settling tank. Higher alloys can be confined to the high-intensity mixer and piping, including the much smaller agitator and shaft. As an alternative to a dynamic mixer (but still a substantial improvement over the traditional batch approach), atmospheric mixing can be performed in a relatively small 904L stainless-steel or Alloy 20 tank and agitator sized at about 750 gallons (about 10 minute retention time). Another alternative is to use one or more static mixers to combine reactants prior to entry into the settling tank.

Suitable high-intensity mixers are commercially available. For instance, suitable equipment is supplied by Head Engineering AB (Sweden) or other similar suppliers. An example is Head Engineering's FXS high-shear mixer, which is designed for use with fats and oils. The exposed areas of the mixer are preferably made using Alloy 20 or 904L stainless-steel to minimize corrosion.

The reaction mixture from the mixer(s) is transferred continuously to a settling tank having a conical lower section and a capacity at least 25 times that of the mixer. Unlike the traditional batch reactor that is typically used, the settling tank used in the inventive process need not be constructed from brick-lined carbon steel or expensive alloys. The bottom of the settling tank features a conical design, which is inclined at least 20 degrees from horizontal, preferably at least 30 degrees from horizontal, at the base. The conical design allows for easy determination of each phase interface and dramatically reduces accumulation of solids that normally occur in a traditional flat-bottom unit.

Preferably, the settling tank is modular, i.e., it is sized to allow its construction inside a shop, followed by transport by buck to the mill at which it will be used. A single settling tank can normally accommodate annual production rates up to 66,000 tons of soap (about 36,000 tons of CTO). For higher volumes, a second settling tank is easily installed. Because the same size and design can be applied to almost any mill, the process has a favorable turn-down ratio. In other words, the plant capacity is readily adjusted by modifying the number of daily cooks performed.

After the reaction mixture is transferred to the settling tank, the batch is allowed to settle to give four phases. In order of decreasing density, the phases include a solid phase comprising calcium sulfate, a clean spent acid phase, a dirty spent acid phase comprising lignin, and a crude tall oil phase. The solid phase contains principally calcium sulfate but may contain other inorganic and organic materials. It may have a sludge-like consistency, but it forms a distinct layer that can be separated as a bottom phase. The clean spent acid phase is aqueous and contains excess sulfuric acid and dissolved sulfate salts, primarily sodium sulfate. The dirty spent acid phase is a “rag layer” that is mostly emulsified organics (including crude tall oil and lignin), water, excess sulfuric acid, and dissolved inorganic salts. The dirty spent acid phase is usually difficult to separate from the desired CTO product. In the traditional batch process, it is difficult to drain al of the upper CTO phase away from the dirty spent acid phase. When continuous separation processes are used, it is also difficult to cleanly separate the rag layer from the CTO phase. The top phase comprises crude tall oil in a form suitable for further purification. It is usually removed and pumped to a wet oil tank or other storage unit to await further processing.

The batch settles into four distinct phases, and each phase is removed sequentially from the settling tank through a port at or near the bottom of the settling tank. The conical bottom and bottom pump out arrangement allow operators to completely empty the settling tank after each cook. Conversely, traditional batch systems often leave the dirty spent add phase in the reactor for multiple cooks and allow it to accumulate, and then add caustic for a “lignin cook” step; alternatively, a lignin cook follows immediately after each tall oil cook. Because the inventive process empties the settling tank after each cook, deposits are reduced, separate lignin cooks are minimized or eliminated, and productivity is increased. Sequential bottom pump out also dramatically reduces losses of CTO in the dirty spent acid phase. Traditional top-phase removal of CTO using skimmer pipes simply cannot be done cleanly without sacrificing the valuable CTO in the rag layer. Moreover, the bottom pump out design eliminates potential worker exposure to hydrogen sulfide when operators peer inside the traditional batch reactor to identify the CTO/rag layer interface.

After removal of the calcium sulfate phase, the clean spent acid phase is removed. It is convenient to combine the clean spent acid phase with caustic as it exits the settling tank, immediately generating a clean alkaline brine phase, preferably having a pH within the range of 10-14. This minimizes the amount of piping that is exposed to a corrosive acid phase. The clean alkaline brine is usually pumped to a tank or other storage unit that is advantageously used to feed a soap washing operation. Preferably, at least a portion of the clean brine is used for soap washing. The dirty spent acid phase (rag layer) is also preferably treated with caustic, preferably to a pH within the range of 10-14, as it exits the settling tank to generate “dirty” alkaline brine. Again, treating this phase immediately with caustic minimizes exposure of piping to corrosive conditions.

In a preferred aspect, the process is used with advanced instrumentation. One or more coriolis sensors, mass-flow meters, or a combination thereof is preferably used to detect phase interfaces, determine the density of phases removed from the settling tank, determine the yield of crude tall oil, or combinations thereof. Because the phases have different densities, Interfaces are easily detected using the coriolis sensor. Operators can also use a sight glass (or remotely operated camera) to help identify interfaces or changes in phase. Coriolis sensors are preferably used on the front end of the process to measure mass flow and density of the soap, and on the back end to measure mass flow and density of the clean spent acid, dirty spent acid, and crude tall oil phases. Effective use of the sensors enables precise interface detection, accurate determination of the mass of each phase, and accounting of other key metrics.

By combining coriolis sensors with on-off actuated valves, the inventive process can lend itself well to distributed control system (DCS) or programmable logic control (PLC) operation, so the process can be automated and operated remotely.

A particular benefit of combining bottom pump out with advanced instrumentation is the ability to segregate—with ease—the clean spent acid phase from the dirty spent acid phase. This allows the clean spent acid phase to be combined with caustic to produce clean alkaline brine, which is valuable for an integrated process utilizing soap washing. In contrast, traditional processes that use continuous decantation or centrifugation must combine the clean and dirty alkaline brines, so an additional separation unit is needed to isolate the clean alkaline brine.

Another advantage of the inventive process compared with processes that use continuous decantation or centrifugation is the ability to operate at higher sodium sulfate concentrations. In continuous product removal designs, the spent acid concentration must be held well below the critical solubility point of sodium sulfate to avoid a process upset, while this consideration is less critical for batch product recovery. When continuous decanting or centrifugation is used, the maximum sodium sulfate concentration is limited to about 15% to prevent premature plugging, while this amount can be increased to closer to 25% when batch-wise recovery is used. Thus, the amount of spent acid generated from the batch process is about 40% lower. This translates into substantial savings when taking into account evaporation costs.

Yet another advantage of the inventive process versus processes that rely on continuous product removal relates to recipe customization. Soap quality often varies considerably depending on its source, yet acidulation units need the flexibility to process different soaps or mixtures thereof. Continuous decantation or centrifugation requires fine tuning; consequently, every change in soap quality forces tedious adjustments in the decanter/centrifuge conditions to account for differences in the soaps. In contrast, separation in the inventive process operates the same way regardless of which soap is used as a starting material for the acidulation, so fine adjustments are not necessary.

The inventive process allows for simple reactor clean-out. Caustic is easily circulated through the mixer and the simple piping connecting the mixer to the settling tank, then through the port at or near the bottom of the settling tank to implement, when desirable, a thorough cleaning.

Because the inventive process makes it easy to generate a clean alkaline brine by neutralizing clean spent acid as it drains from the settling tank, the process is easy to integrate with a process for washing black liquor soap. The clean alkaline brine can simply be pumped without further processing to wash the soap prior to acidulation. The soap washing filtrate from the soap tank can then be piped to the plant's strong liquor system, thereby transporting the calcium extracted from the soap to the recovery boiler. When soap washing is used, the conversion yield of crude tall oil can improve by at least 2%, preferably at least 3%, compared with that of a similar process in which the tall oil soap is not washed with the clean alkaline brine phase. Moreover, when soap washing is used, the calcium content of the tall oil soap can be reduced by at least 30%, preferably at least 50%, compared with that of a similar process in which the tall oil soap is not washed with the clean brine phase. Thus, the recent improvements in soap washing technology discussed in PCT Int. Appl. WO/2012034112, readily integrate with the instant inventive process, enabling improved conversion yields of CTO and better removal of calcium from the soap.

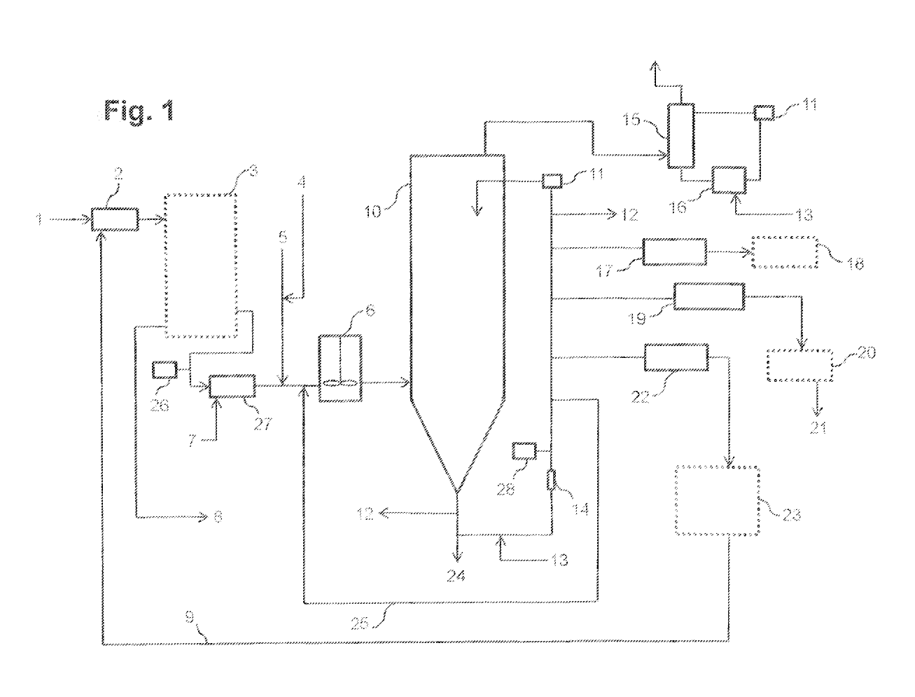

FIG. 1 illustrates a reactor design that utilizes the inventive process, optionally integrated with soap washing. Crude tall oil soap (black liquor soap) (1) enters static mixer (2) where it is preferably combined with clean alkaline brine supplied via the soap pre-treatment piping (9) and transferred to soap storage tank (3). After the soap is washed, the resulting aqueous alkaline brine (or “brine liquor”) is pumped to the plant's strong liquor system (8). Washed soap flows through mass meter (26), is preheated with steam (7), and is then combined with sulfuric acid (4) and water (5) on the way to high-intensity mixer (6). The high-intensity mixer and its agitator are constructed of materials designed to withstand highly corrosive conditions. After a short residence time in the mixer, the reaction products (crude tall oil and spent acid) are transferred to settling tank (10), which has a conical bottom.

Acidic vapors from the top of the settling tank, prior to venting, are neutralized in scrubber (15) and sump (16). Caustic (13) is charged to the sump as needed, and a pH meter (11) is used to continuously measure pH.

The four settled phases (calcium sulfate sludge, clean spent acid, dirty spent acid, and crude tall oil) are withdrawn sequentially through a port at or near the bottom of the settling tank. Phase interfaces are detected using coriolis sensor (28) and/or sight glass (14). Samples can be withdrawn at ports (12). While calcium sulfate is purged (24) from the system, the other products are further processed, with most of the transfers performed in common piping. Thus, the clean spent acid phase is treated with caustic (13) as it is withdrawn from the settling tank to give clean alkaline brine. The clean brine is pumped to a holding unit (22) on site, then typically transferred to a clean brine storage unit (23) for use in the soap washing operation. When the dirty spent acid phase is removed, it is also treated immediately with caustic, and the resulting dirty brine phase is transferred to a holding unit (19). The dirty brine is then usually transferred to a dirty brine storage tank (20), and later to the plant's weak liquor system (21). Finally, the desired crude tall oil phase is removed and transferred to local storage (17) and later to an existing CTO storage facility (18). After any batch is removed, the entire system can be cleaned out by recirculating caustic through line (25), into the mixer (6), then into the settling tank (10).

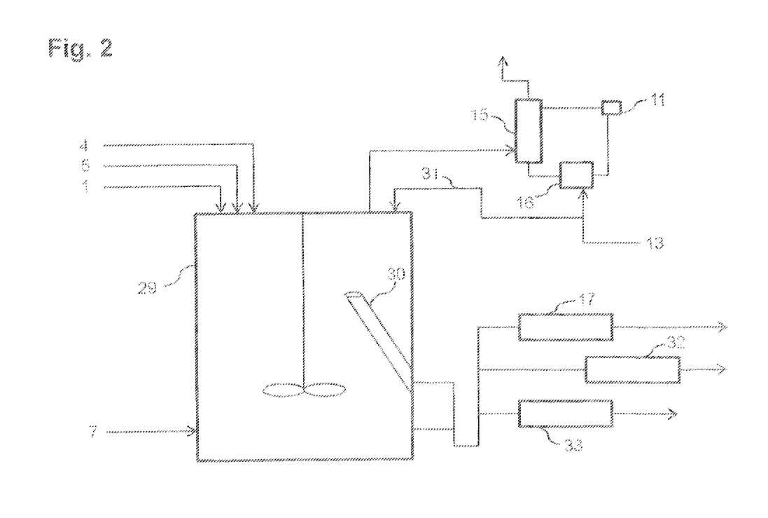

FIG. 2 illustrates a traditional batch acidulation process. Acid brick-lined 40,000 gallon carbon-steel reactor (29) having a large Alloy 20 agitator is charged with black liquor soap (1), sulfuric acid (4), and water (5). Steam (7) is injected to raise the reaction temperature to the desired range (typically 90-95° C.). A scrubber system consisting of scrubber (15), sump (16), pH meter (11), and caustic (13) is in place to treat acidic vapors that exit the top of the reactor. After the acidulation is complete, the reactor contents are allowed to settle. A winch-operated skimmer pipe (30) is used to remove the desired top layer of crude tall oil from the multi-phase reaction mixture. The crude tall oil product is transferred to a CTO storage unit (17). Clean spent acid is pumped to storage (33). Dirty spent acid is often allowed to accumulate in the reactor for one or more subsequent batch reactions. Eventually, it is treated in the reactor with caustic as part of a lignin cook, and the resulting dirty brine is transferred to storage (32). Caustic (13) is supplied to the reactor through line (31) when needed for performing lignin cooks.

Key to FIGS. 1-2

| | |
|---|---|
| 1 | black liquor soap |
| 2 | static mixer |
| 3 | soap storage tank |
| 4 | sulfuric acid |
| 5 | water |
| 6 | high-intensity mixer |
| 7 | steam |
| 8 | brine liquor to strong liquor |
| 9 | soap pre-treatment piping |
| 10 | conical settling tank |
| 11 | pH meter |
| 12 | sampling port |
| 13 | caustic |
| 14 | sight glass |
| 15 | scrubber |
| 16 | sump |
| 17 | crude tall oil (CTO) |
| 18 | to existing CTO storage tank |
| 19 | dirty brine |
| 20 | to dirty brine storage tank |
| 21 | to weak liquor |
| 22 | clean brine |
| 23 | to clean brine storage tank |
| 24 | calcium sulfate purge |
| 25 | clean-in-place recirculation |
| 26 | mass-flow meter |
| 27 | soap heater |
| 28 | coriolis sensor |
| 29 | acid-brick lined reactor, 40K gal |
| 30 | winch-operated skimmer pipe |
| 31 | for lignin cook |
| 32 | lignin cook |
| 33 | spent acid |

The figures and above discussion are meant only as an Illustration; the following claims define the scope of the invention.

We claim:

1. A semi-continuous acidulation process for converting tall oil soap to crude tall oil, comprising:
(a) in one or more mixers, continuously mixing reactants comprising a tall oil soap, sulfuric acid, and water at a temperature within the range of 80° C. to 100° C.;
(b) continuously transferring the reaction mixture(s) from step (a) to a settling tank having a conical lower section and a capacity at least 25 times that of the mixer;
(c) allowing batches of the transferred reaction mixture to settle to give, in order of decreasing density, a solid phase comprising calcium sulfate, a clean spent acid phase, a dirty spent acid phase comprising lignin, and a crude tall oil phase; and
(d) for each batch, removing each phase sequentially from the settling tank through a port at or near the bottom of the settling tank.

2. The process of claim 1 further comprising adjusting the pH of the clean spent acid phase with caustic to pH 10-14 to generate a clean alkaline brine phase.

3. The process of claim 2 wherein at least a portion of the clean brine phase is used to wash the tall oil soap prior to step (a).

4. The process of claim 3 wherein the conversion yield of crude tall oil improves at least 2% compared with that of a similar process in which the tall oil soap is not washed with the clean brine phase.

5. The process of claim 3 wherein the calcium content of the tall oil soap is reduced by at least 30% compared with that of a similar process in which the tall oil soap is not washed with the clean brine phase.

6. The process of claim 1 further comprising adjusting the pH of the dirty spent acid phase with caustic to pH 10-14.

7. The process of claim 1 wherein the reaction mixture transferred from step (a) has an acid concentration less than 5%.

8. The process of claim 1 wherein at least one high-intensity dynamic mixer is used in step (a).

9. The process of claim 8 wherein the mixing in step (a) is performed at a pressure within the range of 1 to 2 bar.

10. The process of claim 1 wherein two or three mixers are used in step (a).

11. The process of claim 1 wherein the mixing in step (a) is performed at atmospheric pressure in a mixer constructed from 904L stainless-steel alloy or Alloy 20.

12. The process of claim 1 wherein the reactants in step (a) are mixed at a temperature within the range of 90° C. to 100° C.

13. The process of claim 1 wherein the settling tank has a capacity within the range of 100 to 500 times that of the mixer.

14. The process of claim 1 wherein the rate of transfer of reaction mixture from the mixer(s) to the settling tank is effective to fill the settling tank within 3 hours.

15. The process of claim 1 wherein a coriolis sensor, mass flow meter, or a combination thereof is used to: (i) detect interfaces; (ii) determine the density of phases removed from the settling tank; (ill) determine the conversion yield of crude tall oil, or (iv) combinations thereof.

16. A remotely operated process of claim 1.

17. A semi-continuous acidulation process for converting tall oil soap to crude tall oil comprising:
(a) in one or more mixers, continuously mixing reactants comprising a tall oil soap, sulfuric acid, and water at a temperature within the range of 80° C. to 100° C.;
(b) continuously transferring the reaction mixture(s) from step (a) to a settling tank having a conical lower section and a capacity at least 25 times that of the mixer;
(c) allowing batches of the transferred reaction mixture to settle to give, in order of decreasing density, a solid phase comprising calcium sulfate, a clean spent acid phase, a dirty spent acid phase comprising lignin, and a crude tall oil phase;
(d) for each batch, removing each phase sequentially from the settling tank through a port at or near the bottom of the settling tank;
(e) adjusting the pH of the clean spent acid phase with caustic to pH 10-14 to generate a clean alkaline brine phase; and
(f) using at least a portion of the clean alkaline brine phase to wash the tall oil soap prior to step (a).

18. The process of claim 17 wherein the conversion yield of crude tall oil improves at least 2% compared with that of a similar process in which the tall oil soap is not washed with the clean brine phase.

19. The process of claim 17 wherein the calcium content of the tall oil soap is reduced by at least 30% compared with that of a similar process in which the tall oil soap is not washed with the clean brine phase.

20. The process of claim 17 wherein a coriolis sensor, mass flow meter, or a combination thereof is used to: (i) detect interfaces; (ii) determine the density of phases removed from the settling tank; (iii) determine the conversion yield of crude tall oil, or (iv) combinations thereof.
